(19) United States
(12) Patent Application Publication
(10) Pub. No.: US 2012/0008627 A1
(43) Pub. Date: Jan. 12, 2012

(54) METHOD AND APPARATUS FOR ASSIGNING DEVICE IDENTIFIER WITH COLLISION AVOIDANCE

(76) Inventors: Yung-Han Chen, Hsinchu (TW); Ming-Hung Tao, Tainan (TW); Fang-Ching Ren, Hsinchu (TW)

(21) Appl. No.: 13/083,594

(22) Filed: Apr. 11, 2011

Related U.S. Application Data
(60) Provisional application No. 61/362,765, filed on Jul. 9, 2010.

(51) Int. Cl. H04L 12/28

(52) U.S. Cl. 370/392

(57) ABSTRACT

One exemplary embodiment of the invention provides an apparatus to assign device identifier with collision avoidance in a distributed network environment. The apparatus may operate, for example, by using different control areas for different group of anchor DIDAFs, or the serving DIDAF/node may assign or cancel a set of available device IDs for an anchor DIDAF/node, so the anchor DIDAF/node may assign a device ID for a device in a control area of the serving DIDAF/node within the set of the available device IDs. In additions, the used and unused device ID assignment may be filtered by the serving DIDAF/node to allow or reject the device ID assignment or the serving DIDAF/node may translate the used device ID assigned by an anchor DIDAF/node to another unused device ID.

### TECHNICAL FIELD

The disclosure generally relates to a method and apparatus for assigning device identifier with collision avoidance.

### BACKGROUND

A Device Identification Assignment Function (DIDAF) is responsible for the identification or identifier (ID) assignment process of the device. The DIDAF dominates its own control areas. Each of the control areas may consist of one or multiple base stations, access points, routers, switches, signal distributors, etc. The DIDAF or the node with DIDAF may manage one or multiple DIDAF control areas, where the node represents a network component that includes one or multiple network-related functions such as control-related function, management-related function, configuration-related function, storage-related function, routing-related function, etc. A DIDAF may communicate with other DIDAFs or nodes directly or indirectly via networks or some interfaces or channels or the like.

FIG. 1 shows functional blocks of nodes with DIDAF in distributed deployment. As shown in FIG. 1, a node may own one or multiple DIDAFs in the operation of device ID assignment. For example, Node A owns one DIDAF, while Node N owns n DIDAFs. The ID of a device may be assigned by the DIDAF which manages the control area that covers the device. In the operation of device ID assignment, the command of a DIDAF may be executed through the node. The ID of a device may be assigned by the DIDAF which does not manage the control area that covers the device. Two cases, the cross-node case and the inner-node cross-DIDAF case, may be considered.

FIG. 2 shows an exemplary cross-node device ID assignment. For example, the DIDAF 202 in Node A may assign an ID to Device 1 which is in the DIDAF control area 210 of the DIDAF 212 in Node C. Here the DIDAF 202 in Node A is denoted as the anchor DIDAF of Device 1, and the DIDAF 212 in Node C is denoted as the serving DIDAF. The DIDAF/node, such as DIDAF 212 or Node C, whose control area covers Device 1 acts like a relay or an agent which executes the assignment command from the DIDAF in Node A. Anchor DIDAF of Device 1 in Node A may assign an ID to Device 1 which is under the serving DIDAF control area of Node C. Similarly, the anchor DIDAF of Device 2 in Node B may assign an ID to Device 2 which is under the same serving DIDAF control area of Node C. If the IDs assigned to Devices 1 and 2 (or more devices) are the same, then collision occurs, as shown in FIG. 3. The major impact of collision is that, for example, Device 2 will respond to the signal or data which is actually for Device 1, and vice versa.

One of the usual issues is device ID collision in idle mode operation. For example, a mobile station (MS) in idle mode is configured a set of paging parameters, including deregistration ID (DID), paging cycle, paging offset, to identify its own paging message. The set of paging parameters is assigned by the anchor paging controller (APC) of the MS. A paging controller (PC) including the capability of DIDAF may control one or multiple paging groups (i.e. control areas). For example, when MS1 enters a paging group (PG) but the serving PC is not its APC1, MS1 will ask its APC1 to assign the set of paging parameters through serving PC or the serving gateway. Here the serving PC or the serving gateway acts as a relay. It is possible for another APC2 to assign the same paging parameters for another MS2 in the same PG, and then collision occurs. This is because that there is no interaction between APC1 and APC2. In this case, a paging message for MS 1 will also wake MS2 up to perform unnecessary network re-entry.

One U.S. Patent document disclosed a system that uses a centralized server to coordinate assigning identifiers in a distributed computing system. The system operates by receiving a request for a block of identifiers at the centralized server from a requesting node in the distributed computing system. In response to this request, the system selects a block of identifiers from a global pool of identifiers, and then marks the global pool of identifiers to indicate that the selected block of identifiers has been assigned. In order to allow the requesting node to assign identifiers from the selected block of identifiers without having to communicate with the centralized server, the system sends the selected block of identifiers to the requesting node. Upon receiving an indication that the selected block of identifiers is no longer being used by the requesting node, the system marks the global pool of identifiers to indicate that the selected block of identifiers is no longer assigned.

Another U.S. Patent publication document disclosed a method for allocating provisional unit IDs (PUIDs) and provisional group IDs (PGIDs) to subscriber units and groups during a failure, such that when the communication system recovers, there is a decrease in or elimination of the number of dropped or missed communications. The technique reserves a range of provisional PUIDs and PGIDs for resource controllers when subscriber units roam into the failure region. The technique also addresses creating PUID and PGID ranges for resource controllers to assign to roaming subscriber units in order to allow for assignment of PUIDs and PGIDs during periods of subsystem isolation and site trunking, i.e., when the particular site or subsystem miss or drop communications with the rest of the communication system.

Yet another U.S. Patent document disclosed a packet communication system constructed with a plurality of terminal side devices and a network side device including a dynamic ID assigning portion and a time slot allocation portion. The dynamic ID assigning portion transmits ID information assigned to the respective terminal side devices in an initial setting state to the respective terminal side devices by means of a control signal. When an ID assignment release request is received from an ID control portion of the terminal side device in a usual state, the dynamic ID assigning portion changes the state of an ID assigned to the terminal side device to the non-assigned state. The dynamic ID assigning portion searches IDs in the non-assigned state when an ID assigning request is received. When there is an ID in the non-assigned state, changes the state of the ID to the assigned state. Then the dynamic ID assigning portion notifies the terminal side device from which the ID assigning request is transmitted of the ID assigned to the terminal side device.

Through real Internet Protocol (IP) address hiding behind the client/proxy and localized incremental of quantity of IP address, network address translation (NAT) based solution may eliminate the ID collision in a distributed network environment. There may be more efficient techniques to eliminate the ID collision in a distributed network environment.

### SUMMARY

The exemplary embodiments of the present disclosure may provide a method and apparatus for assigning device identifier with collision avoidance.

A disclosed exemplary embodiment relates to a method for assigning device identifier with collision avoidance, performed in a distributed network environment at least having a serving DIDAF or serving node, N control areas called control area 1˜control area N, M devices called device 1˜device M, and L anchor DIDAFs called DIDAF 1˜DIDAF L therein. The method comprises: once the serving DIDAF or serving node receiving a device ID request trigger message from a device i, the serving DIDAF or serving node sending the device ID request trigger message with an ID of an assigned control area j to an anchor DIDAF k; the anchor DIDAF k sending a device ID response message with an assigned device ID to the serving DIDAF or serving node; and the serving DIDAF or serving node sending the device ID response message with the assigned device ID and the ID of the assigned control area j to the device i. Wherein i is from 1 to M, and for those control areas j and anchor DIDAF k, 1≦j≦N, 1≦k≦L, the serving DIDAF or serving node configures different control areas for different anchor DIDAFs or different groups of anchor DIDAFs.

Another exemplary embodiment relates to a method for assigning device identifier with collision avoidance, performed in a distributed network environment having a serving Device Identification Assignment Function (DIDAF) or serving node and at least an anchor DIDAF or anchor node therein. The method comprises: the serving DIDAF or serving node representing a plurality of available device IDs by indexes of set, with the range of a set of available device IDs being predefined; and whenever the serving DIDAF or serving node receiving a device ID assignment message from an anchor DIDAF, the serving DIDAF or serving node checking a flag in the device ID assignment message to assign or cancel a set of available device IDs for the anchor DIDAF.

Yet another disclosed exemplary embodiment relates to an apparatus for assigning device identifier with collision avoidance in a distributed network environment. The distributed network environment has at least a serving DIDAF/node, a plurality of control areas, a plurality of devices, and a plurality of anchor DIDAFs/nodes therein. The apparatus may comprise an ID management unit and an ID assigner. The ID management unit is configured to receive a device ID request trigger message from a device, trigger the serving DIDAF/node for assigning one of the plurality of control areas, and send the device ID request with the assigned control area to the ID assigner. The ID assigner is configured to receive the device ID request with the assigned control area, trigger one of the plurality of anchor DIDAFs/nodes for assigning a device ID, and send a device ID response with the assigned control area and the assigned device ID to the ID management unit. The ID management unit then sends the device ID response message with the assigned control area and the assigned device ID to the device requesting the device ID. Wherein, the device ID assignment for the assigned ID is done in the anchor DIDAF/node, and different control areas of the plurality of control areas are used for different anchor DIDAFs/nodes of the plurality of anchor DIDAFs/nodes.

Yet another disclosed exemplary embodiment relates to an apparatus for assigning device identifier with collision avoidance in a distributed network environment. The distributed network environment has at least a serving DIDAF/node and at least an anchor DIDAFs/nodes therein. The apparatus may comprise an ID management unit and an ID assigner. The ID management unit is configured to represent a plurality of available device IDs by indexes of set, receive a device ID assignment message from an anchor DIDAF, and trigger the serving DIDAF or serving node to check a flag in the device ID assignment message to assign or cancel a set of available device IDs for the anchor DIDAF. The ID assigner is configured to trigger the anchor DIDAF to trigger the anchor DIDAF to assign or cancel a device ID for a device in a control area of the serving DIDAF/node within the set of the available device IDs.

The foregoing and other features, aspects and advantages of the disclosure will become better understood from a careful reading of a detailed description provided herein below with appropriate reference to the accompanying drawings.

### BRIEF DESCRIPTION OF THE DRAWINGS

FIG. 1 shows functional blocks of nodes with DIDAF in distributed deployment in conventional techniques.

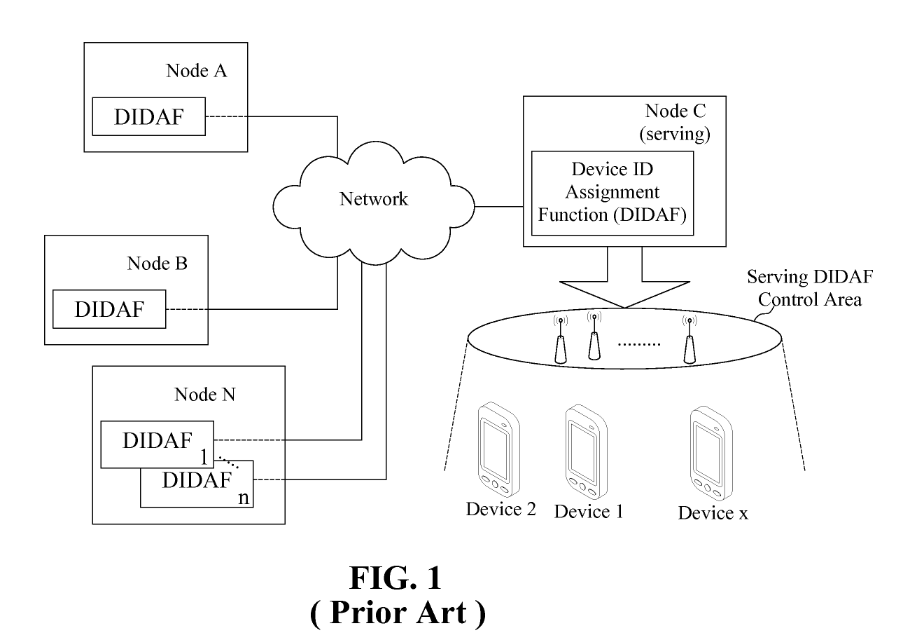

FIG. 2 shows an exemplary cross-node device ID assignment in conventional techniques.

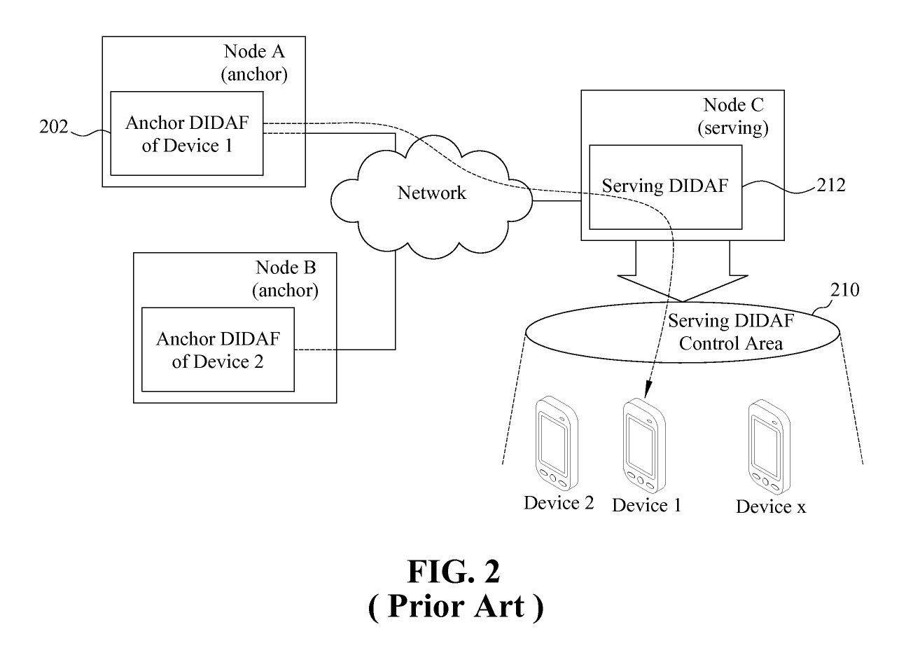

FIG. 3 shows an example of device ID collision of FIG. 2.

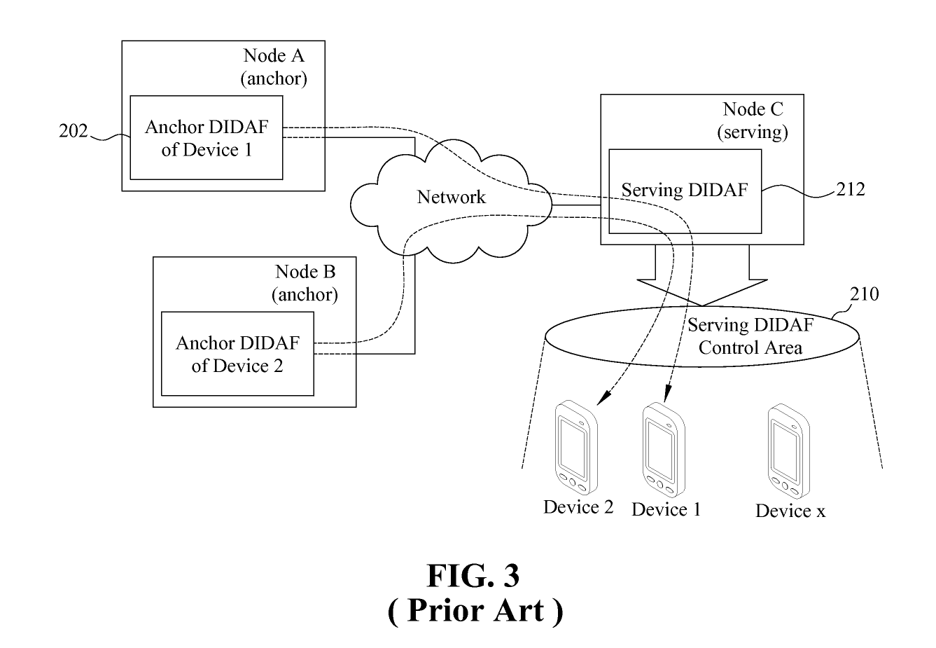

FIG. 4 shows an exemplary schematic view illustrating different DIDAFs associate with different control areas, consistent with certain disclosed embodiments.

FIG. 5 shows an exemplary schematic view illustrating one control area may be with multiple control area IDs, consistent with certain disclosed embodiments.

FIG. 6 shows an exemplary procedure of different serving DIDAF/node control areas for different anchor DIDAFs, consistent with certain disclosed embodiments.

FIG. 7 shows an exemplary procedure of different serving DIDAF/node control areas for different anchor DIDAFs in WiMAX network, consistent with certain disclosed embodiments.

FIG. 8 shows an exemplary flowchart of a method for assigning device identifier with collision avoidance, consistent with certain disclosed embodiments.

FIG. 9 shows a flowchart for assigning device identifier with collision avoidance, in which a serving DIDAF or serving node assigns or cancels a set of available device IDs for the anchor DIDAF, consistent with certain disclosed embodiments.

FIG. 10 shows an exemplary flow chart of filtering used or unused device ID assignment at the serving DIDAF or serving node, consistent with certain disclosed embodiments.

FIG. 11 illustrates an exemplary scenario of translating the used device ID assigned by an anchor DIDAF/node to another unused device ID for a WiMAX network, consistent with certain disclosed embodiments.

FIG. 12 shows an exemplary block diagram of an apparatus for assigning device identifier with collision avoidance in a distributed network environment, consistent with certain disclosed embodiments.

FIG. 13 shows another exemplary block diagram of an apparatus for assigning and canceling available device identifier to achieve collision avoidance in a distributed network environment, consistent with certain disclosed embodiments.

### DETAILED DESCRIPTION OF THE EXEMPLARY EMBODIMENTS

The exemplary embodiments disclose an efficient technology to assign device identifier to eliminate the collision of device ID assignment in a distributed network environment. For example, the solutions may employ different serving DIDAF/node control areas for different anchor DIDAFs, or serving DIDAF/node may assign/cancel a set of available devices IDs for the anchor DIDAF, or used/unused device ID assignment may be recorded and filtered by serving DIDAF/node to permit or reject the use of device ID, or the serving DIDAF/node may translate the device ID assigned by an anchor DIDAF/node to another unused device ID when duplication of ID assignment occurs.

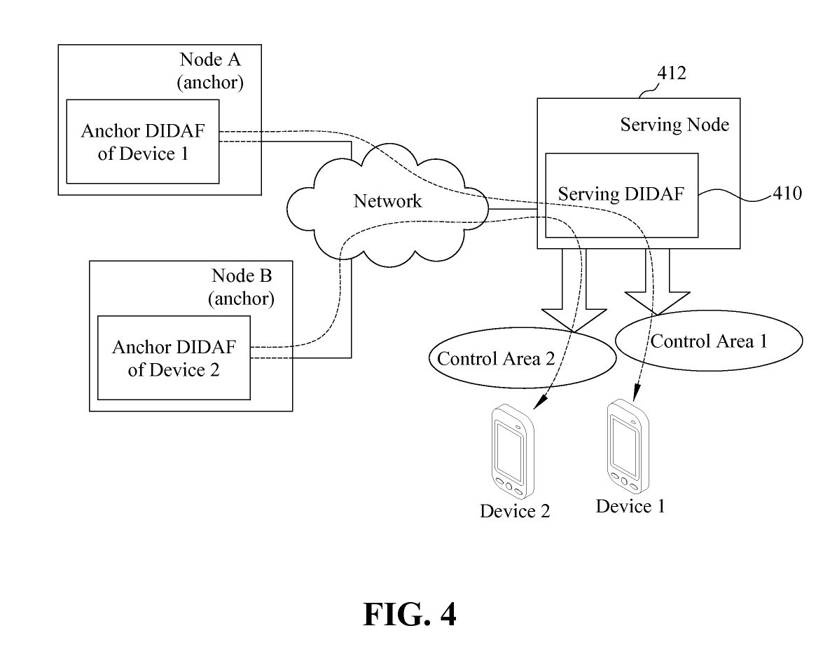

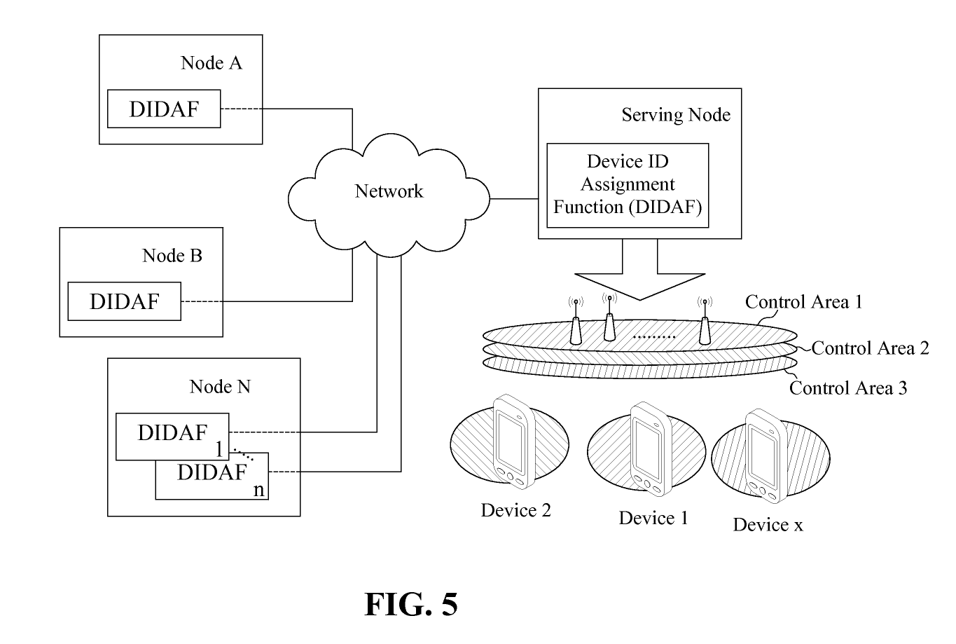

FIG. 4 shows an exemplary schematic view illustrating different anchor DIDAFs associate with different control areas, consistent with certain disclosed embodiments. Referring to FIG. 4, serving DIDAF 410 or serving node 412 may configure different control areas for different anchor DIDAFs. For example, serving DIDAF 410 or serving node 412 may configure control area 1 for anchor DIDAF of device 1, and control area 2 for anchor DIDAF of device 2. Each control area will have a unique identifier number. Different control areas may be geographically totally-overlapped with each other. For example, control area 1 and control area 2 may be geographically totally-overlapped with each other. In the case of FIG. 4, one control area may be with multiple control area IDs, as shown in the example of FIG. 5. For example, control area 1 may be with multiple predefined control area IDs. Each base station may be associated with more than one control areas.

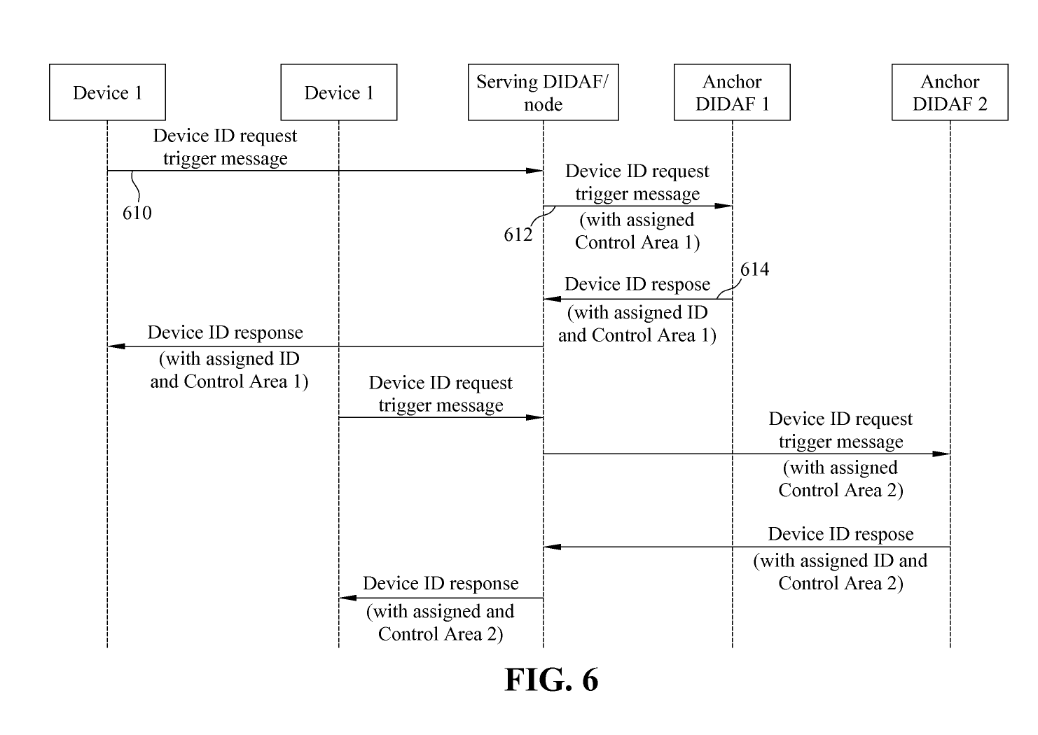

FIG. 6 shows an exemplary procedure of different serving DIDAF/node control areas for different anchor DIDAFs, consistent with certain disclosed embodiments. Referring to FIG. 6, device 1 sends a device ID request trigger message 610 to the serving DIDAF/node. Upon receiving the message 610, the serving DIDAF/node sends the message (with an assigned control area 1) to the anchor DIDAF 1. The anchor DIDAF 1 replies a device ID response (with an assigned ID and the control area 1) 614 to the serving DIDAF/node, in response to the receiving the message (with an assigned control area 1) 612. The serving DIDAF/node further sends the device ID response (with an assigned ID and the control area 1) 614 to the device 1. If another device, for example device 2, sends a device ID request trigger message to the serving DIDAF/node, similar steps may be performed, but another assigned control area, for example control area 2, with an assigned ID is sent to the another device. If the control area number assignment is already done before sending the Device ID request trigger message to the anchor DIDAF, then the messages between serving DIDAF/node and anchor DIDAF may not have to contain the assigned control area number.

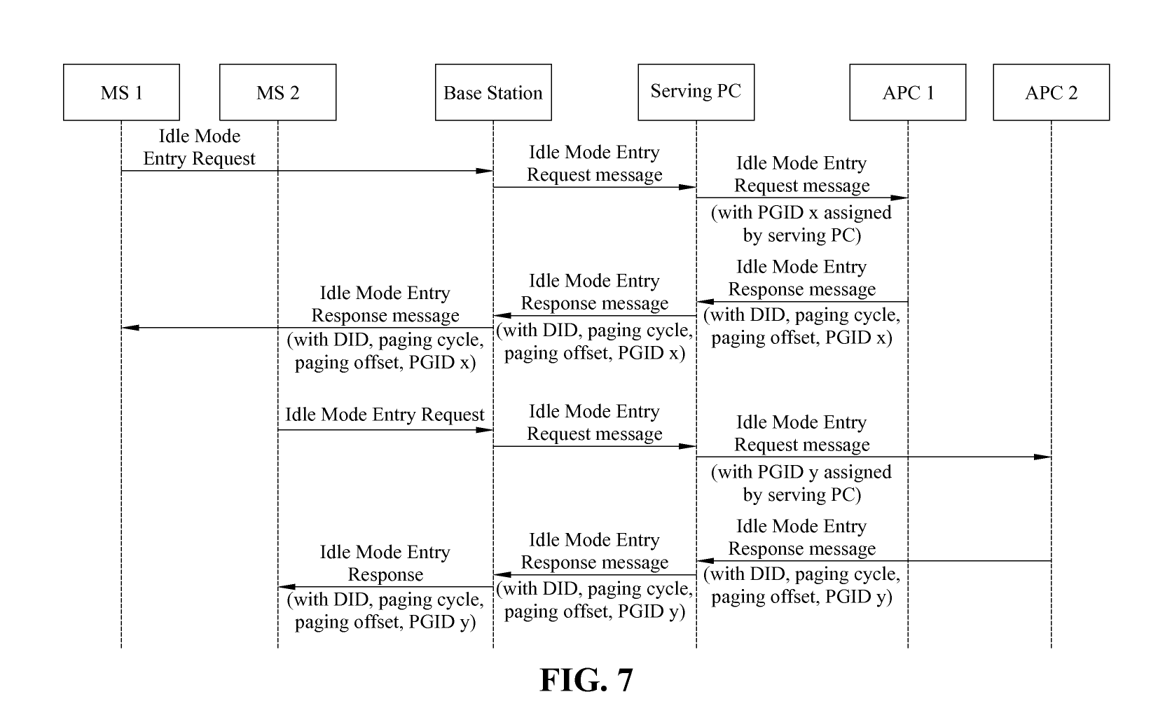

FIG. 7 shows an exemplary procedure of different serving DIDAF/node Control Areas for different anchor DIDAFs in WiMAX network, consistent with certain disclosed embodiments. In FIG. 7, the serving DIDAF is represented by the serving paging controller (PC); the anchor DIDAF is represented by the anchor PC (APC); the device is represented by the mobile station (MS); the control area is represented by the paging group; the device ID is represented by the deregistration ID (DID). Referring to FIG. 7, MS 1 may send an Idle Mode Entry Request to the associated base station (BS), and the BS sends an Idle Mode Entry Request message to the serving PC in the serving node such as a serving gateway. If MS 1 does not belong to the serving PC, the serving PC or the serving gateway may send an Idle Mode Entry Request message with the paging group ID (PGID) x assigned by the serving PC or serving GW to the corresponding APC of MS 1. The DID assignment is done in the APC. A PGID may be corresponded with an APC or a group of APCs. The Idle Mode Entry Response message sent by the APC may be further with DID, paging cycle and paging offset in the case of the WiMAX network. It is also possible that if the PG is managed by a node such as a gateway (GW), the Idle Mode Entry Request message from the BS or the Idle Mode Entry Response message from the APC can be treated by the GW, wherein the serving PC may not be involved directly.

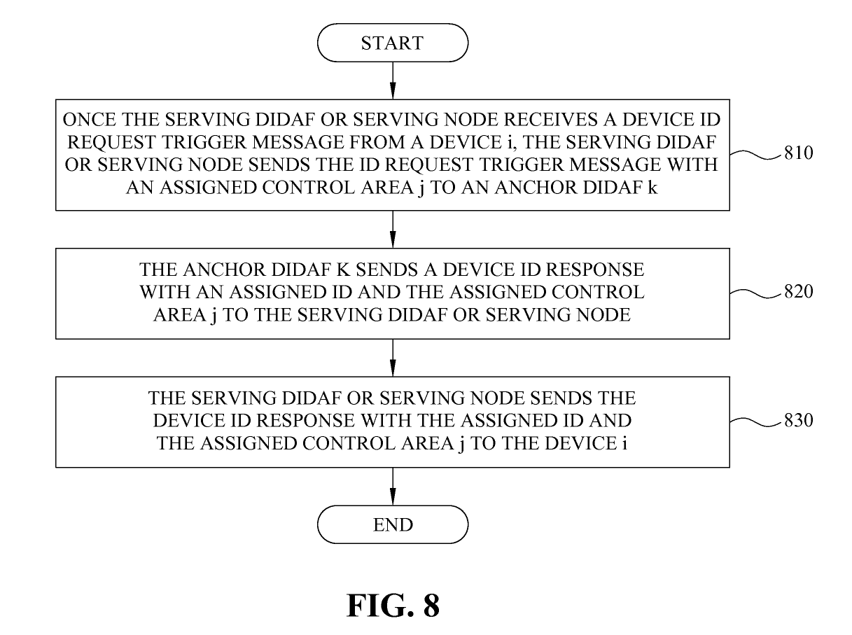

Now, a method for assigning device identifier with collision avoidance performed in a distributed network environment will be described with reference to FIG. 8, which shows a flowchart of the assigning device identifier method. In FIG. 8, the distributed network environment has at least a serving DIDAF or serving node, N control areas called control area 1˜control area N, M devices called device 1˜device M, and L anchor DIDAFs called DIDAF 1˜DIDAF L therein. Once the serving DIDAF or serving node receives a device ID request trigger message from a device i, the serving DIDAF or serving node sends the ID request trigger message with an assigned control area j to an anchor DIDAF k (step 810). The anchor DIDAF k sends a device ID response with an assigned ID and the assigned control area j to the serving DIDAF or serving node (step 820). The serving DIDAF or serving node sends the device ID response with the assigned ID and the assigned control area j to the device i (step 830). Where i is from 1 to M, and for those control areas j and anchor DIDAF k, 1≦j≦N, 1≦k≦L, the serving DIDAF or serving node configures different control areas for different anchor DIDAFs.

In FIG. 8, the device ID assignment may be initiated by a trigger message which may be a dedicated message to request device ID or a message that will trigger ID assignment process. As mentioned earlier, the serving DIDAF may also notify those anchor DIDAFs of the assigned control area numbers before sending the device ID request trigger message. The device ID assignment for the assigned ID is done in the anchor DIDAF k, and the serving DIDAF or serving node will executes at least an assignment command included in the device ID response from the anchor DIDAF k, 1≦k≦L. Each control area is assigned a unique identifier number, such as page group ID (PGID) in the environment of the WiMAX network. Different control areas may be geographically totally-overlapped with each other. The unique identifier for a control area number may be corresponded with an anchor DIDAF or a group of anchor DIDAFs.

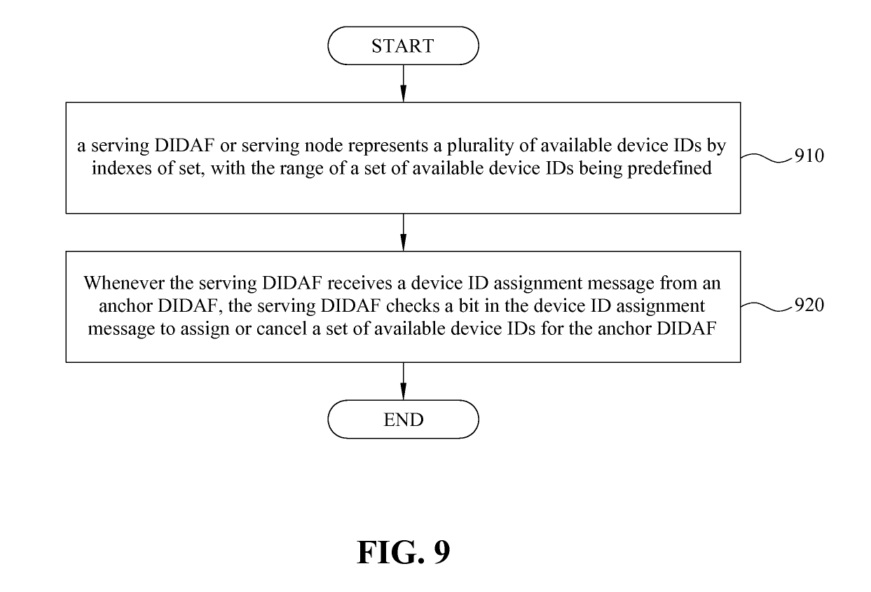

Now, another exemplary embodiment for assigning device identifier with collision avoidance performed in a distributed network environment will be described. In the exemplary embodiment, a serving DIDAF assigns or cancels a set of available device IDs for the anchor DIDAF, and the device ID assignment is done in the anchor DIDAF. FIG. 9 shows a flowchart for assigning device identifier with collision avoidance according to the scenario of the embodiment. In FIG. 9, a serving DIDAF or serving node represents a plurality of available device IDs by indexes of set, with the range of a set of available device IDs being predefined (step 910). For example, there may be 5 sets of available device IDs represented by set 1˜set 5, and 100 device IDs in a set. Whenever the serving DIDAF receives a device ID assignment message from an anchor DIDAF, the serving DIDAF checks a flag in the device ID assignment message to assign or cancel a set of available device IDs for the anchor DIDAF (step 920). So that the anchor DIDAF may assigns a device ID for the device in the control area of the serving DIDAF within the set of the available device IDs. A bit is required in the device ID assignment message to indicate the assignment or cancellation of the set of available device IDs.

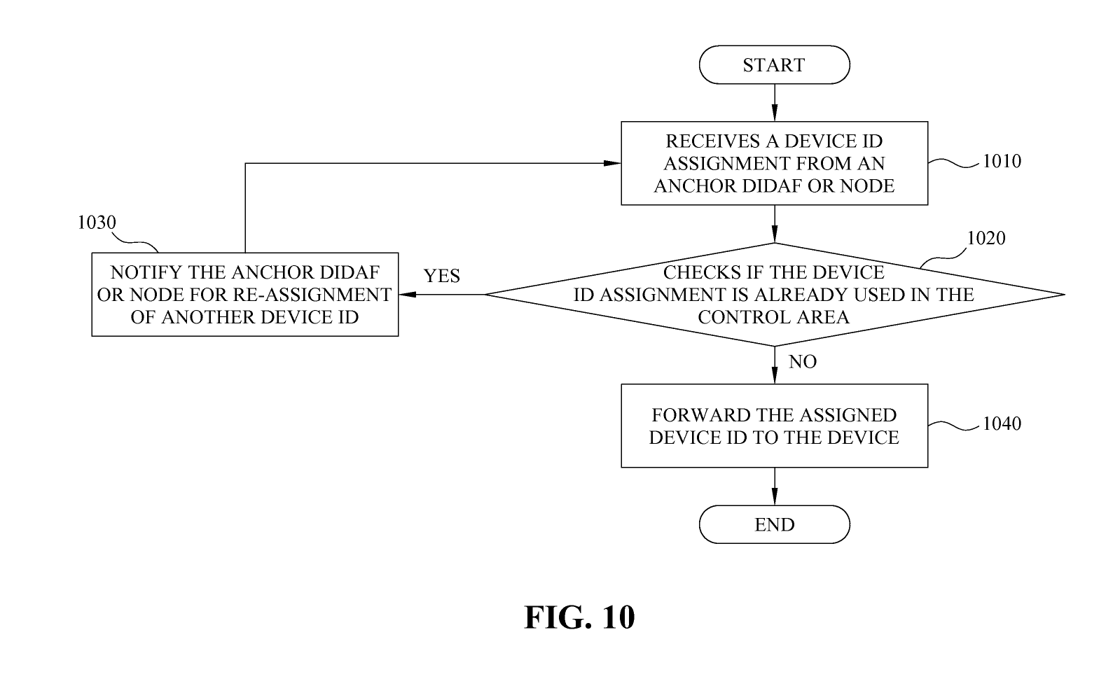

In the embodiment of FIG. 8 or FIG. 9, whenever the serving DIDAF or serving node receives the device ID assignment message for those devices under the serving DIDAF control area of the serving node, the serving DIDAF or serving node may further check if the device ID is already used in the control area. In other words, used or unused device ID assignment may further be filtered by the serving DIDAF or serving node to allow or reject the device ID assignment. FIG. 10 shows an exemplary flow chart of filtering used or unused device ID assignment at the serving DIDAF or serving node, consistent with certain disclosed embodiments.

Referring to FIG. 10, whenever the serving DIDAF or serving node receives a device ID assignment from an anchor DIDAF or node (step 1010), the serving DIDAF or serving node checks if the device ID assignment is already used in the control area (step 1020). If the assigned device ID is already used, the serving DIDAF or serving node may implicitly or explicitly notify the anchor DIDAF or node for re-assignment of another device ID (step 1030). In other words, the serving DIDAF or serving node may implicitly or explicitly notify to the anchor DIDAF or node to indicate that the device ID is already used. Then the anchor DIDAF or node re-assigns another device ID to the device. Both implicitly reply and explicitly reply may be performed. If the implicitly reply is performed, the serving DIDAF or serving node does not reply anything to the anchor DIDAF or node, which will wait for timer expiration and re-assign another device ID to the device. If the explicitly reply is performed, the serving DIDAF/node will reply a message to the anchor DIDAF or node with the ID assignment failure because of ID duplication. If the assigned device ID is not used yet, the serving DIDAF or serving node will forward the assigned device ID to the device (step 1040). In the example of FIG. 10, the serving DIDAF/node needs to be able to decode or recognize the device ID in the assignment message from the anchor DIDAF or node. Additional message exchanges between the serving DIDAF/node and the anchor DIDAF/node are required to accept or reject the device ID assignment by the corresponded anchor DIDAF/node. The Device ID assignment is done in the anchor DIDAF/node.

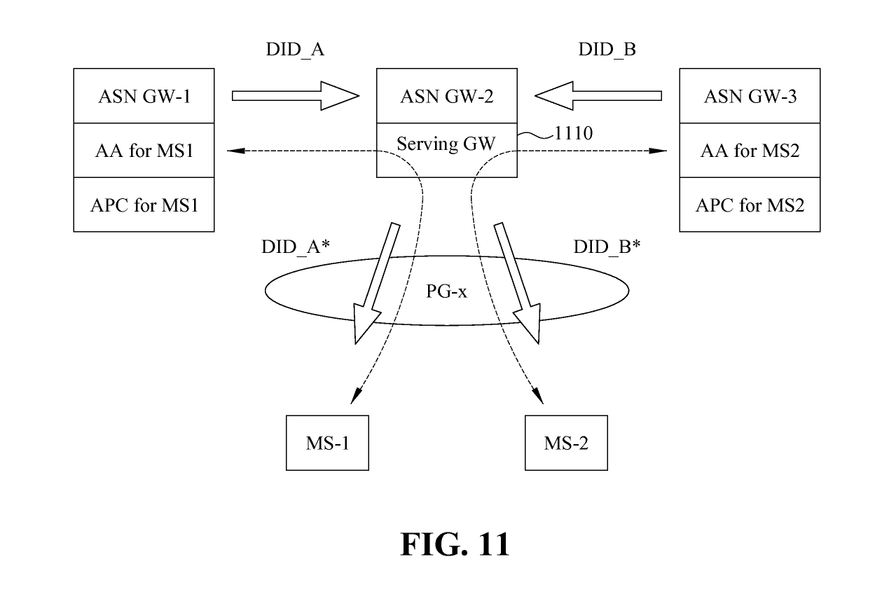

As mentioned earlier, if the serving DIDAF/node is able to decode or recognize the device ID in the assignment message from the anchor DIDAF/node, used or unused device ID assignment may be further filtered by the serving DIDAF/node. Yet another exemplary embodiment for assigning device identifier with collision avoidance performed in a distributed network environment will be described. In the exemplary embodiment, the serving DIDAF/node may translate the device ID assigned by an anchor DIDAF/node to another unused Device ID. If the original device ID assigned by the anchor DIDAF/node is not used yet, then it does not need translation. In addition, the serving DIDAF/node needs to maintain a translation table to perform a correct mapping between anchor DIDAF/node and the device. The device ID translation may be grouped, that is, a device ID from a certain anchor DIDAF/node will be translated to another device ID value in a certain set/range of device IDs. FIG. 11 illustrates an exemplary scenario of this exemplary embodiment for a WiMAX network, consistent with certain disclosed embodiments.

Referring to FIG. 11, a serving gateway (GW) will translate deregistration ID (DID) assignment based on an anchor GW in the WiMAX network. The anchor GWs in an access service network (ASN), for example ASN GW-1, or ASN GW-2 or ASN GW-3, may still perform distributed management but the serving GW 1110 translates the assigned DID_A and DID_B to DID_A* and DID_B* respectively, where DID_A* and DID_B* may be kept different by the serving GW 1110. With the DID assignment translation by the serving GW 1110, when, for example, mobile stations MS 1 and MS2 enter a page group PG-x, it may eliminate the ID collision occurring on MS1 and MS2. There may be two translation rules. First, the serving DIDAF/node may translate a used device ID assigned by an anchor DIDAF/node to another unused device ID. Second, the serving DIDAF/node may translate any device ID assigned by an anchor DIDAF/node to an unused Device ID.

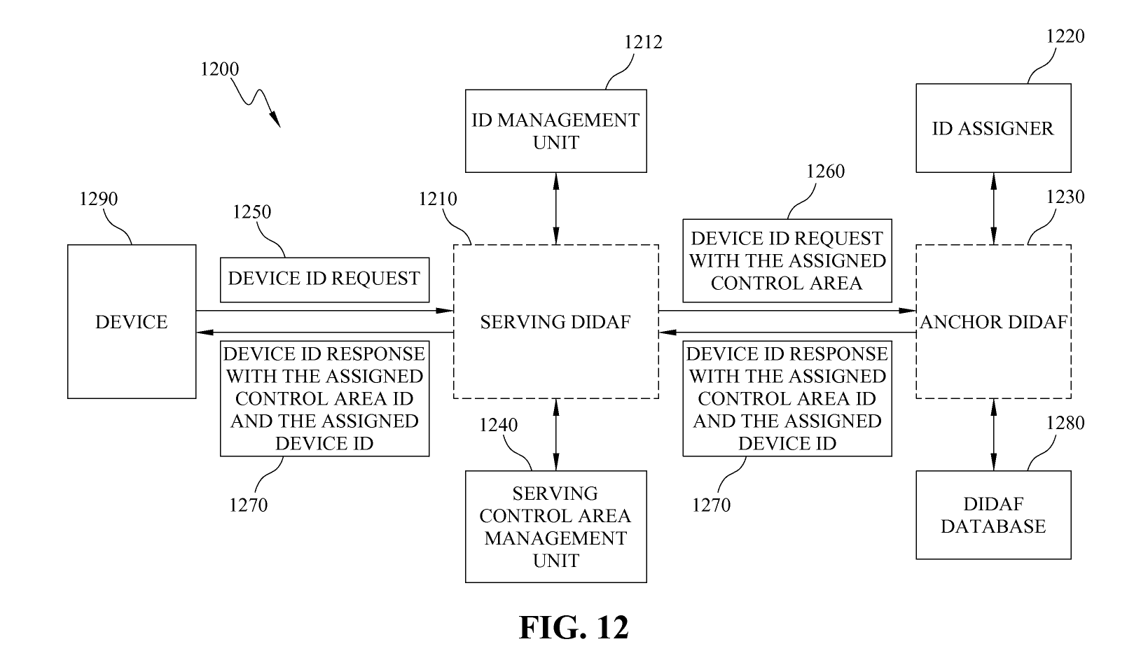

Now, an apparatus for assigning device identifier with collision avoidance employed in a distributed network environment will be described with reference to FIG. 12, which shows an exemplary block diagram of the apparatus employed in a distributed network environment, consistent with certain disclosed embodiments. The distributed network environment has at least a serving node including at least a serving DIDAF 1210, a plurality of control areas, a plurality of devices, and a plurality of anchor nodes including at least an anchor DIDAF 1230 therein. Referring to FIG. 12, the apparatus for assigning device identifier 1200 may comprise an ID management unit 1212 associated with a serving DIDAF (such as serving DIDAF 1210), a serving control area management unit 1240, an ID assigner 1220 associated with an anchor DIDAF (such as anchor DIDAF 1230), and a DIDAF database 1280. The ID management unit 1212 is configured to receive a device ID request 1250 from a device 1290, trigger the serving control area management unit 1240 for assigning one of the plurality of control areas, and send the device ID request with the assigned control area 1260 to ID assigner 1220. ID assigner 1220 is configured to receive the device ID request with the assigned control area ID, trigger its action of device ID assignment to generate a device ID, trigger the DIDAF database 1280 to record or update the status and details of the ID assignment, and send a device ID response with the assigned control area ID and the assigned device ID 1270 to ID management unit 1212. ID management unit 1212 then sends the device ID response with the assigned control area ID and the assigned device ID 1270 to the device 1290 requesting the device ID. Wherein, the device ID assignment for the assigned ID is done by the ID assigner 1220 in the anchor DIDAF 1230 of the anchor node, and different control areas of the plurality of control areas are used for different anchor DIDAFs or anchor nodes of the plurality of anchor DIDAFs or anchor nodes. In the exemplary embodiment of FIG. 12, the ID management unit 1212 may be configured in the serving DIDAF/node 1210, and the ID assigner 1220 may be configured in the anchor DIDAF 1230 or anchor node.

In the exemplary embodiment of FIG. 12, a device ID assignment for the assigned ID is done by the ID assigner in the anchor DIDAF or anchor node. The device ID assignment which is used or unused may be further filtered by the serving DIDAF or serving node to allow or reject said device ID assignment. The serving DIDAF or serving node may also translate a device ID assigned by the ID assigner in the anchor DIDAF or anchor node to another unused device ID. For this translation, the serving DIDAF or serving node needs to maintain a translation table to perform a correct mapping between the anchor DIDAF (or anchor) node and the device.

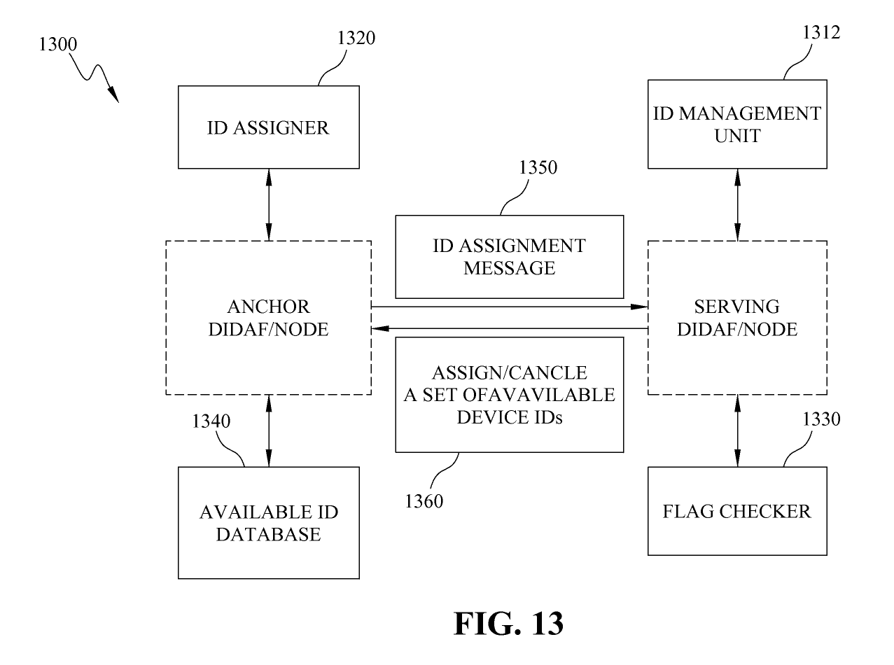

Another exemplary embodiment of an apparatus for assigning and canceling available device identifier to achieve collision avoidance employed in a distributed network environment will be described with reference to FIG. 13, in which the apparatus 1300 may comprises an ID management unit 1312, a flag checker 1330, available ID database 1340, and an ID assigner 1320. The ID management unit 1312 is configured to represent a plurality of available device IDs by indexes of set, receive a device ID assignment message from an anchor DIDAF/node, and trigger the flag checker 1330 in the serving DIDAF/node to check a flag in the ID assignment message 1350 to assign or cancel a set of available device IDs 1360 for the anchor DIDAF. The anchor DIDAF/node may be configured to maintain an available ID database 1340 according to the assigning or canceling result from the serving DIDAF/node. Based on the assigning/canceling results or the available ID database 1340, the ID assigner 1320 is configured to assign a device ID for a device in the control area of the serving DIDAF/node within the set of the available device IDs. The range of a set of available device IDs may be predefined.

Similarly, in the exemplary embodiment of FIG. 13, a device ID assignment for the assigned ID may be done in the anchor DIDAF/node that includes the ID assigner. The used or unused device ID assignment may be filtered by the serving DIDAF or serving node to allow or reject said device ID assignment. The serving DIDAF or serving node may translate a device ID assigned by the anchor DIDAF to another unused device ID.

Although the disclosure has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for assigning device identifier (ID) with collision avoidance, performed in a distributed network environment at least having a serving Device Identification Assignment Function (DIDAF) or serving node, N control areas called control area 1˜control area N, M devices called device 1˜device M, and L anchor DIDAFs called DIDAF 1˜DIDAF L therein, said method comprising:
once said serving DIDAF or serving node receiving a device ID request trigger message from a device i, said serving DIDAF or serving node sending said ID request trigger message with an assigned ID of control area j to an anchor DIDAF k;
said anchor DIDAF k sending a device ID response with an assigned device ID to said serving DIDAF or serving node; and;
adding all the physical blocks referred in said CL or said BIL to a garbage collection related change list (GC-CL); and
said serving DIDAF or serving node sending said device ID response with said assigned device ID and said assigned control area j to the device i;
wherein i is from 1 to M, and for those control areas j and anchor DIDAF k, 1≦j≦N, 1≦k≦L, said serving DIDAF or serving node configures different control areas for different anchor DIDAFs or different groups of anchor DIDAFs.

2. The method as claimed in claim 1, wherein a device ID assignment for said assigned device ID is done in said anchor DIDAF k.

3. The method as claimed in claim 1, wherein said serving DIDAF or serving node executes at least an assignment command included in said device ID response from said anchor DIDAF k, and 1≦k≦L.

4. The method as claimed in claim 1, wherein each of said N control areas is assigned a unique identifier number.

5. The method as claimed in claim 4, wherein if the control area identifier number assignment is already done, then the messages between said serving DIDAF and said anchor DIDAF k does not require to contain the assigned control area identifier number j.

6. The method as claimed in claim 4, wherein said unique identifier number for a control area is corresponded with an anchor DIDAF or a group of anchor DIDAFs.

7. The method as claimed in claim 2, wherein for said assigned device ID which is used or unused is further filtered by said serving DIDAF or serving node to allow or reject said device ID assignment.

8. The method as claimed in claim 2, wherein said assigned device ID which is used or unused is further filtered by said serving DIDAF or serving node to translate the used device ID assigned by said anchor DIDAF k to another unused device ID.

9. A method for assigning device identifier (ID) with collision avoidance, performed in a distributed network environment having a serving Device Identification Assignment Function (DIDAF) or serving node and at least an anchor DIDAF or anchor node therein, said method comprising:
said serving DIDAF or serving node representing a plurality of available device IDs by indexes of set, with the range of a set of available device IDs being predefined;
and
whenever said serving DIDAF or serving node receiving a device ID assignment message from an anchor DIDAF or anchor node, said serving DIDAF or serving node checking a flag in said device ID assignment message to assign or cancel a set of available device IDs for the anchor DIDAF or anchor node.

10. The method as claimed in claim 9, wherein a bit for said flag is required to indicate assign or cancel the set of available device IDs for said anchor DIDAF or anchor node.

11. The method as claimed in claim 9, wherein a device ID assignment is done in said anchor DIDAF or anchor node.

12. The method as claimed in claim 11, wherein said device ID assignment which is used or unused is further filtered by said serving DIDAF or serving node to allow or reject said device ID assignment.

13. The method as claimed in claim 11, wherein said device ID assignment which is used or unused is further filtered by said serving DIDAF or serving node to translate the used device ID assigned by said anchor DIDAF or anchor node to another unused device ID.

14. An apparatus for assigning device identifier (ID) with collision avoidance employed in a distributed network environment having at least a serving node including at least a serving Device Identification Assignment Function (DIDAF), a plurality of control areas, a plurality of devices, and a plurality of anchor nodes including at least an anchor DIDAF therein, said apparatus comprising:
a serving control area management unit;
an identifier (ID) management unit that is configured to receive a device ID request from a device, trigger said serving control area management unit for assigning one of the plurality of control areas, and send the device ID request with the assigned control area to an ID assigner; and
said ID assigner that is configured to receive said device ID request with the assigned control area identifier number, trigger its action of a device ID assignment to generate a device ID, trigger a DIDAF database to record or update the status and details of the ID assignment, and send a device ID response with an assigned control area identifier number and the assigned device ID to said ID management unit;
wherein, said ID management unit then sends said device ID response with the assigned control area identifier number and the assigned device ID to said device requesting the device ID, and different control area identifier numbers of said plurality of control areas are used for different anchor DIDAFs or anchor nodes of said plurality of anchor DIDAFs or anchor nodes.

15. The apparatus as claimed in claim 14, wherein a device ID assignment for the assigned ID is done by said ID assigner in the anchor DIDAF or anchor node.

16. The apparatus as claimed in claim 15, wherein said device ID assignment which is used or unused is further filtered by said serving DIDAF or serving node to allow or reject said device ID assignment.

17. The apparatus as claimed in claim 15, wherein said device ID assignment which is used or unused is further filtered by said serving DIDAF or serving node to translate the used device ID assigned by said anchor DIDAF or anchor node to another unused device ID.

18. The apparatus as claimed in claim 17, wherein said serving DIDAF or serving node further maintains a translation table to perform a correct mapping between the device and the anchor DIDAF or anchor node.

19. An apparatus for assigning device identifier (ID) with collision avoidance employed in a distributed network environment having at least a serving Device Identification Assignment Function (DIDAF) or serving node and at least an anchor DIDAF or anchor node therein, said apparatus comprising:
an identifier (ID) management unit that is configured to represent a plurality of available device IDs by indexes of set, receive a device ID assignment message from an anchor DIDAF or anchor node, and trigger the serving DIDAF or serving node to check a flag in said device ID assignment message to assign or cancel said set of available device IDs for said anchor DIDAF or anchor node; and
an identifier (ID) assigner that is configured to assign or cancel a device ID for a device in a control area of the serving DIDAF or serving node within said set of the available device IDs.

20. The apparatus as claimed in claim 19, wherein the anchor DIDAF or anchor node is configured to maintain an available ID database according to an assigning or cancelling result from the serving DIDAF or serving node.

21. The apparatus as claimed in claim 19, wherein the range of a set of available device IDs is predefined.

22. The apparatus as claimed in claim 19, wherein a device ID assignment for the assigned ID is done in the anchor DIDAF or anchor node.

23. The apparatus as claimed in claim 21, wherein said device ID assignment which is used or unused is further filtered by said serving DIDAF or serving node to allow or reject said device ID assignment.

24. The apparatus as claimed in claim 21, wherein said device ID assignment which is used or unused is further filtered by said serving DIDAF or serving node to translate the used device ID assigned by said anchor DIDAF or anchor node to another unused device ID.
